(19) United States
(12) Patent Application Publication
(10) Pub. No.: US 2010/0204969 A1
(43) Pub. Date: Aug. 12, 2010

(54) SYSTEM AND METHOD FOR THREAT PROPAGATION ESTIMATION

(75) Inventors: Nathan S. Hariharan, Vernon, CT (US); Troy Ray Smith, Hartford, CT (US); Andrzej Banaszuk, Simsbury, CT (US); Satish Narayanan, Ellington, CT (US)

Correspondence Address: KINNEY & LANGE, P.A., THE KINNEY & LANGE BUILDING, 312 SOUTH THIRD STREET, MINNEAPOLIS, MN, 55415, US

(73) Assignee: United Technologies Corporation, Hartford, CT (US)

(21) Appl. No.: 12/733,757

(22) PCT Filed: Sep. 19, 2007
(86) PCT No.: PCT/US07/20315

§ 371 Date: Mar. 18, 2010

(51) Int. Cl. G06F 17/10; G06G 7/48; G06N 7/02

(52) U.S. Cl. 703/2; 703/6; 706/52; 706/45

(57) ABSTRACT

A threat propagation estimator generates threat propagation estimates for a region based on a combination of sensor data (z) and model-based threat propagation estimates. The threat propagation estimator receives sensor data (z) from one or more sensor devices, and employs threat propagation model (M) to generate a model-based threat propagation estimate. A threat propagation algorithm (20) is used to combine the sensor data (z) and the model-based threat propagation estimate to generate a threat propagation estimate (Jc).

### BACKGROUND

The present invention is related to threat detection in buildings, and more specifically to estimation of threat propagation based, on sensor data and modeling.

Sensors are commonly employed in buildings and other areas to detect the presence of threats, such as fire, smoke, and chemical agents. Typical sensors however only provide a binary output regarding the presence of a threat (i.e., threat detected or no threat detected). Thus, first responders typically have very little information regarding the source of the threat or the likely propagation of the threat through the building. Valuable resources are oftentimes required to locate and neutralize a threat. In addition, without information regarding the likely propagation of the threat, it is difficult to prioritize the evacuation of occupants and to select proper evacuation routes.

### SUMMARY

A system for estimating threat propagation in a region includes inputs cooperatively connected to receive sensor data from one or more sensor devices and a threat propagation device. A threat propagation estimator is operably connected to the input to receive the sensor data. The threat propagation estimator executes an algorithm that generates a threat propagation estimate based on the received sensor data and a threat propagation model that generates a model-based threat propagation estimate. An output is operably connected to the threat propagation estimator to communicate the threat propagation estimate.

In another aspect, a method of estimating the propagation of a threat in a region includes acquiring sensor data from one or more sensor devices; calculating a model-based threat propagation estimate based on a threat propagation model that predicts the expected propagation of a threat through the region; and generating a threat propagation estimate based on a combination of the acquired sensor data and the model-based threat propagation estimate.

In another aspect, a system for estimating the propagation of a threat within a region includes at least one sensor device for acquiring sensor data capable of detecting threats. The system further includes means for calculating a model-based threat propagation estimate based on a threat propagation model that predicts the expected propagation of a threat through a region, and means for generating a threat propagation estimate based on a combination of the acquired sensor data and the model-based threat propagation estimate.

In another aspect, described herein is a distributed system for estimating the propagation of threats within a region. The distributed system includes a first threat propagation estimator operatively connected to receive sensor data associated with a first region and for executing an algorithm to generate a first threat propagation estimate for the first region based on the received sensor data associated with the first region and a first threat propagation model that generates a model-based threat propagation estimate for the first region. The distributed system also includes a second threat propagation estimator connectable to receive sensor data associated with a second region and for executing an algorithm to generate a second threat propagation estimate for the second region based on the received sensor data associated with the second region and a second threat propagation model that generates a model-based threat propagation estimate for the second region.

In another aspect, described herein is a computer readable storage medium encoded with a machine-readable computer program code for generating threat propagation estimates for a region, the computer readable storage medium including instructions for causing a controller to implement a method. The computer program includes instructions for acquiring input from one or more sensor devices. The computer program also includes instructions for calculating a model-based threat propagation estimate based on a threat propagation model that predicts movements of threats within a region. The computer program further includes instructions for generating a threat propagation estimate for the region based on a combination of the acquired sensor input and the model-based threat propagation estimate.

### BRIEF DESCRIPTION OF THE DRAWINGS

FIG. 1 is a schematic of a floor of a building divided into a number of sub-regions.

FIG. 2 is a flowchart illustrating an exemplary embodiment of the calculation of threat propagation estimates based on sensor data and a predictive threat propagation model.

FIG. 3 is a flowchart illustrating an exemplary embodiment of the generation of the predictive threat propagation model.

FIG. 4 is a flowchart illustrating an exemplary embodiment of an algorithm employed to generate threat propagation estimates.

FIG. 5 is a block diagram of an exemplary embodiment of a threat propagation system.

FIGS. 6A-6C are block diagrams illustrating a number of distributed threat propagation estimation systems.

### DETAILED DESCRIPTION

Disclosed herein is a system and method for estimating the propagation of threats (e.g., smoke, fire, chemical agents, etc.) through a region based on data provided by sensor devices and threat propagation models. A threat propagation model is a real-time tool that models how threats (such as smoke or chemical agents) will propagate through the region. The sensor data and the threat propagation model are provided as inputs to a threat propagation algorithm. The threat propagation algorithm combines the sensor data provided by the sensors with the threat propagation model to provide a threat propagation estimate that describes the propagation of the threat through a region.

The term ‘threat propagation estimate’ is used generally to describe data that describes the propagation or movement of threats through a region. The threat propagation estimate may include, for example, estimates regarding the distribution of particles throughout the region including distribution estimates for individual sub-regions, probabilities associated with the estimates of particle distribution, reliability data indicative of the confidence associated with a threat propagation estimate as well as estimates regarding the likely source of the threat and likely future propagation of the threat. In addition, the term ‘region’ is used throughout the description and refers broadly to an entire region as well as individual sub-regions or cells making up the larger region. Thus, threat propagation estimates made for a region may include threat propagation estimates for each individual sub-region of the region (e.g., particle distributions for each individual sub-region).

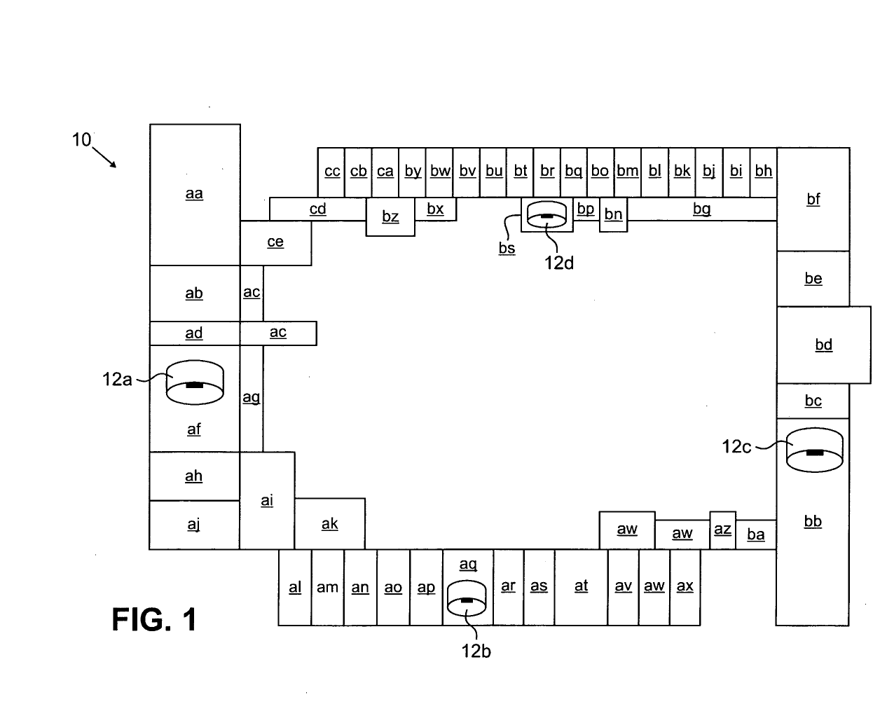

FIG. 1 illustrates an example that will be used throughout this description to aid in describing the threat propagation algorithm, in which threat propagation estimates are made for a particular floor of a building. The concepts described with respect to this embodiment can be applied in a variety of settings or locations (e.g., outdoors, train stations, airports, etc.).

FIG. 1 illustrates the layout of a single floor of building 10 divided into a number of individual cells or sub-regions labeled ‘aa’-‘ce’. Threat detection sensors 12a, 12b, 12c, and 12d are located in various sub-regions of building 10, with threat detection sensor 12a located in sub-region ‘af’, threat detection sensor 12b located in sub-region ‘aq’, threat detection sensor 12c located in sub-region ‘bb’, and threat detection sensor 12d located in sub-region ‘bs’. In this embodiment, the floorplan associated with building 10 is divided based on the location of individual rooms and hallways, although regions may be divided in a variety of ways depending on the application (i.e., regions may be divided into smaller or larger sub-regions or different criteria may be used to divide a region into sub-regions). Threat detection sensors 12a-12d may provide binary data indicating the presence of a detected threat, or may provide more detailed information including, for instance, the type of threat detected or the concentration levels associated with a detected threat.

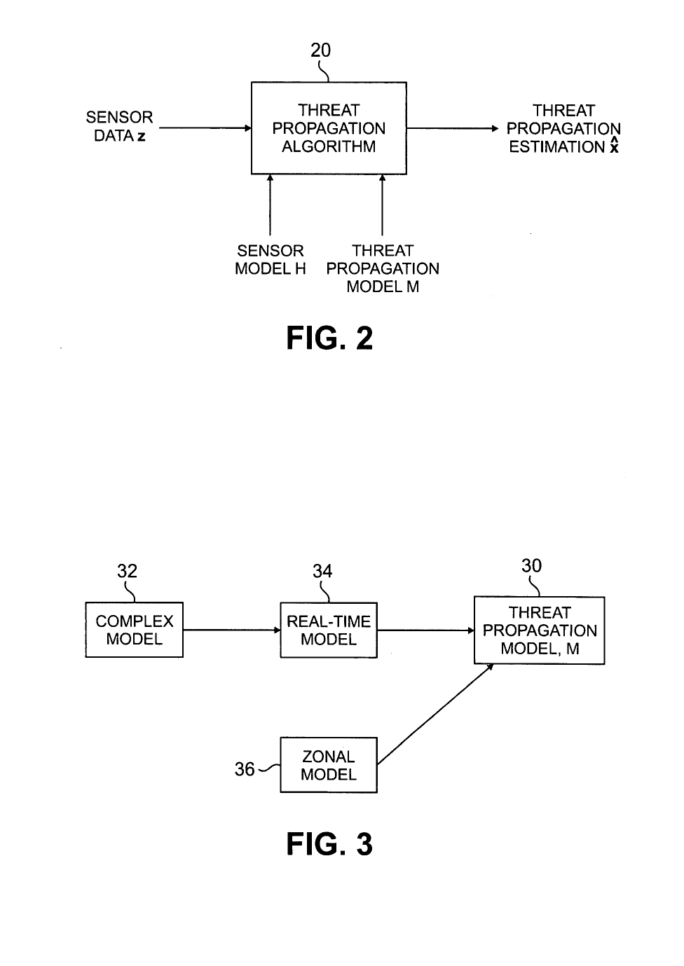

FIG. 2 is a high-level block diagram illustrating an exemplary embodiment of the inputs provided to threat propagation algorithm 20 as well as outputs generated by threat propagation algorithm 20. Inputs provided to threat propagation algorithm 20 include sensor data z (provided by one or more sensor devices), sensor model H, and threat propagation model M. Sensor data z may be provided by one or more sensor devices (for example, by sensor devices 12a-12d as shown in FIG. 1). Sensor data z is represented as a vector in this embodiment, wherein the vector represents threat detection data provided by each of the threat detector sensors. In an exemplary embodiment, the threat detection sensors measure and provide as part of sensor data z the concentration level of a detected threat (e.g., concentration of smoke particles). Concentration data may in turn by used calculate the number of particles located in a particular sub-region at which the threat detection sensor is located.

Threat propagation model M provides a model that predicts how threats will propagate through a region (described in more detail with respect to FIG. 3). Thus, given an initial set of conditions (i.e., detection of a threat in one or more sub-regions), propagation model M is able to make real-time estimates regarding how the threat will propagate through each sub-region. For example, based on the embodiment shown in FIG. 1, if a concentration of smoke particles are detected by threat detection sensor 12a, threat propagation model M generates estimates regarding how the smoke in sub-region ‘af’ (i.e., the location of threat detection sensor 12a) will propagate to surrounding sub-regions. Threat propagation model M may take into account a number of factors such as interconnection between adjacent sub-regions, the operation of ventilation systems as well as factors such as pressurization of stairwells in buildings.

For instance, in an exemplary embodiment, threat propagation model M is generated based on a computational fluid dynamic (CFD) simulation that models a particular region taking into account factors describing the layout of a region. Based on the computational fluid dynamic simulation, the movement of threats (e.g., smoke particles) can be mapped at different intervals of time. The CFD simulation is a complex and time-consuming process however (e.g., a single simulation may take several hours or even several days to complete) and therefore cannot be used to provide real-time estimates of threat propagation. However, based on the simulation and tracking of particle movements, a model can be generated to reflect the expected movement of particles from one sub-region to adjacent sub-regions. For instance, in an exemplary embodiment a Markov matrix is generated in response to the CFD simulation to describe the movement of particles from one sub-region to an adjacent sub-region as shown by the following equation:

$${M}_{ij} = \frac{{N}_{i -> j}}{{\sum }_{j = 1} {N}_{i -> j}} \qquad Equation 1$$

As described by Equation 1, Mᵢⱼ is a matrix representing particle movement from each sub-region to adjacent sub-regions, N_{i→j} represents the number of particles that move from sub-region i to adjacent sub-region j during a specified time-interval, and ΣN_{i→j} represents a sum of movement between sub-region i and all neighboring sub-regions. For instance, with respect to the example shown in FIG. 1, Nᵢ₌ⱼ may represent the particles that move from sub-region ‘af’ to adjacent sub-region ‘ag’, and ΣNᵢ₌ⱼ would represent the sum of particle movement from sub-region ‘ag’ to adjacent sub-regions ‘ad’, ‘ae’, ‘ag’, ‘ai’ and ‘ah’. In this way, the denominator in Equation 1 ensures that the sum of each row in Markov matrix Mᵢⱼ (i.e., the probability associated with particles moving from one sub-region to an adjacent sub-region) is unity. The result is a Markov matrix Mᵢⱼ that provides probabilities associated with particles from one sub-region propagating to another sub-region in a selected time interval. Markov matrix Mᵢⱼ can therefore be used to estimate the propagation of the threats through each sub-region based on an initial detection of a threat.

Based on the Markov matrix Mᵢⱼ, the propagation of threats (e.g., particles) through various sub-regions can be predicted at future time intervals using the following equation.

xⁿ⁺¹=Mᵢⱼxⁿ+wⁿ Equation 2

In this equation, xⁿ represents the threat distribution at time n (e.g., the distribution of smoke particles in each sub-region at time n), xⁿ⁺¹ represents the threat distribution at time n+1, Mᵢⱼ is the Markov matrix described above, and wⁿ represents process noise. This equation represents an exemplary embodiment of how threat propagation at future instances of time can be estimated based, in part, on a threat propagation model such as the Markov matrix Mᵢⱼ and a previous estimate of threat propagation xⁿ. In this way, the propagation of a threat can be estimated in real-time or near real-time.

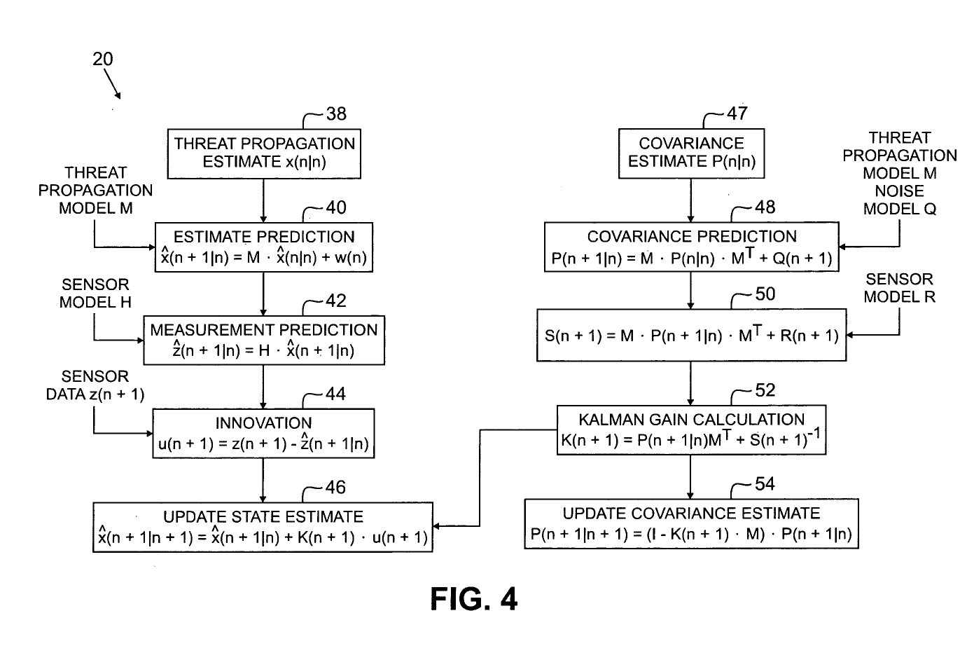

As described in more detail with respect to FIG. 4, the threat propagation model (e.g., Markov model) M is provided as an input to the threat propagation algorithm 20. The threat propagation algorithm also receives as input sensor data z provided by one or more sensor devices. Based on the received sensor data z and the threat propagation model M, threat propagation algorithm 20 generates a threat propagation estimate \hat{x}. In an exemplary embodiment, threat propagation estimate \hat{x} is a vector that represents the estimated distribution of a threat throughout all sub-regions (including those sub-regions that do not include a threat detection device). For instance, in an exemplary embodiment threat propagation estimate \hat{x} would represent a distribution of smoke particles throughout each sub-region (e.g., cells ‘aa’, ‘ab’, ‘ac’, etc. as shown in FIG. 1) at a particular time n. It should be noted that threat propagation estimate \hat{x} is based on both sensor data z and threat propagation model M. However, if sensor data z is not available or if there have been no changes to sensor data z, then threat propagation estimate \hat{x} may be based only on the propagation estimates generated by the threat propagation model M. In this way, even without the benefit of sensor data z (for instance, if sensors are lost or destroyed by the threat), threat propagation algorithm 20 is able to generate threat propagation estimates \hat{x} into the near future, as well as into the past to estimate the likely source of the threat.

FIG. 3 is a flow chart illustrating an exemplary embodiment regarding the generation of threat propagation model M (represented by the box labeled ‘30’) based on more computational complex simulations or models. In this way, threat propagation model 30 is capable of providing accurate and reliable estimates of threat propagation in real-time. In contrast, the computationally complex simulations on which threat propagation model 30 is based may take many hours or days to complete a simulation regarding how a threat will propagation through a region.

In the exemplary embodiment shown in FIG. 3, threat propagation model 30 is generated based on complex model 32, real-time model 34, and zonal model 36. In an exemplary embodiment, complex model 32 is a computational fluid dynamic model (CFD) that simulates how particles move through a region. Complex model 32 is defined by the physical layout of the region for which the simulation is run, as well as attributes of the region such as pressure differences between sub-regions, or ventilation flows within the region. In this way, complex model 32 accurately simulates the propagation of particles (i.e., threats) through the region at different intervals at time. Based on the result of the simulations run by complex model 32, and the resulting particle distributions generated at different intervals of time, real-time model 34 can be generated to define the expected probability of particles moving from one region to another region. For example, in an exemplary embodiment real-time model 34 is a Markov matrix that defines the probability of particles moving from one sub-region to adjacent sub-regions. Depending on the application, the generation of real-time model 34 (e.g., a Markov matrix) may be sufficient for a particular application and may be used as threat propagation model 30 without further enhancements. As described above, a Markov matrix provides real-time estimates regarding the expected propagation of particles from sub-regions to adjacent sub-regions. In another exemplary embodiment, real-time model 34 is a probability of detection (POD) model that generates real-time estimates regarding the expected propagation of particles from sub-regions to adjacent sub-regions. In this embodiment, the Markov matrix and the POD model are alternatives to one another, although in another embodiment they may be used in conjunction with one another to provide a real-time estimate of the expected propagation of particles from sub-region to sub-region.

In addition, in an exemplary embodiment zonal model 36 may be used in combination with real-time model 34 to generate threat propagation model 30. In particular, zonal model 36 is employed to provide estimates of threat propagations in smaller regions such as corridors connecting rooms in a building. In this embodiment, real-time model 34 provides estimates of threat propagation in larger areas (e.g., large room or atrium) and zonal model 36 provides estimates of threat propagation in smaller areas (e.g., small rooms or hallways). For instance, zonal model 36 may model smaller spaces as one-dimensional areas with probabilities associated with the propagation of the threat between adjacent regions. Zonal model 36 is provided in addition to real-time model 34 to generate threat propagation model 30, which may then be used to generate estimates of how threats will propagate through all sub-regions (large and small) of a region.

In other embodiments, complex model 32 may be used to generate a real-time model 34 that models threat propagations in sub-regions both large and small, obviating the need for zonal model 36. As described in more detail with respect to FIG. 4, the threat propagation model 30 is used in conjunction with sensor data to generate threat propagation estimates for a region or sub-regions.

FIG. 4 is a flowchart illustrating an exemplary embodiment of the threat propagation algorithm 20 for generating threat propagation estimates \hat{x} (n) based on inputs that include sensor data z(n), sensor model H, and threat propagation model M. In the embodiment shown in FIG. 4, threat propagation algorithm 20 is implemented with an Extended Kalman Filter (EKF). The left side of FIG. 4 illustrates the algorithm steps employed to update the threat propagation estimate \hat{x}(n) (i.e., estimates of threat or particle distributions located through the region), while the right side of FIG. 4 illustrates the algorithm employed to generate a covariance estimate P(n). The covariance estimate P(n) is a measure of the uncertainty associated with the threat propagation estimate \hat{x}(n).

In this embodiment, calculating or updating of the threat propagation estimate begins with an initial state or current threat propagation estimate. For example, threat propagation estimation will not begin until a threat is detected. Therefore, in an exemplary embodiment, the location of the sensor first detecting a threat is used to initialize the threat propagation algorithm (i.e., is provided as the previous estimate \hat{x}(n|n)). In another embodiment, there is no need to initialize the Extended Kalman Filter because in the first iteration of the Extended Kalman Filter the sensor data z(n+1) provided by a threat detection sensor first detecting a threat will result in an updated threat propagation estimate \hat{x}(n+1|n+1) that will act to initialize the system in the next iteration of the EKF algorithm. The notation of the threat propagation estimates \hat{x}(n|n) denotes that this is threat propagation estimate at a time n, based on observations from time n (i.e., combination of both model outputs and sensor updates). In contrast, the notation \hat{x}(n+1|n) indicates that the propagation estimate is for a time n+1, but is based on sensor data provided at time n. In the exemplary embodiment shown in FIG. 4, threat propagation estimates are updated with new sensor data at each time-step. However, in other embodiments threat propagation estimates may be generated many time steps into the future in order to predict the likely path of the threat.

At step 40, threat propagation model M is applied to a previous threat propagation estimate \hat{x}(n|n), along with process noise w(n) to generate threat propagation prediction \hat{x}(n+1|n) (i.e., a model-based estimate of threat propagation). That is, the expected movement of a threat at a future time step is predicted based on the current threat propagation estimate \hat{x}(n|n) and the threat propagation model M. For example, as described with respect to FIG. 2, the threat propagation model M may be constructed as a Markov Matrix based on computational fluid dynamic simulations. The notation \hat{x}(n+1|n) denotes that this is a model-based prediction for time n+1 based on observations made at time n (i.e., the update is not based on the most recently observed events). At step 42, sensor model H is applied to occupancy prediction \hat{x}(n+1|n) to generate measurement prediction \hat{z}(n+1|n). Measurement prediction \hat{z}(n+1|n) represents the expected sensor measurements based on the threat propagation prediction \hat{x}(n+1|n). For instance, in the exemplary embodiment described with respect to FIG. 1, if threat propagation prediction \hat{x}_{aq}(n+1|n) predicts a threat propagating into sub-region ‘aq’, then measurement prediction \hat{z}_{aq}(n+1|n) will indicate that threat detection sensor 12b should detect the presence of a threat.

At step 44, measurement prediction \hat{z}(n+1|n) is compared with actual sensor data z(n+1) to generate a difference signal represented by the innovation variable u(n+1). In an exemplary embodiment, innovation u(n+1) indicates the difference between expected sensor \hat{z}(n+1|n) (calculated at step 34) and the actual observed sensor outputs z(n+1). For example, based on the example described above, if threat propagation prediction \hat{x}_{aq}(n+1|n) estimates that the threat has propagated to sub-region ‘aq’, but threat detection sensor 12b returns a value indicating that no threat has been detected, then innovation variable u_{aq}(n+1) will indicate that a difference exists between the expected propagation of the threat and the propagation of the threat as reported by the sensors. The innovation variable is used to correct differences between model-based threat propagation prediction \hat{x}(n+1|n) and sensor data z(n+1).

At step 46, the threat propagation estimate \hat{x}(n|n) is updated based on threat propagation prediction \hat{x}(n+1|n), innovation u(n+1) and a gain coefficient K(n+1) discussed in more detail with respect to the covariance calculations. As indicated by this equation, the updated threat propagation estimate \hat{x}(n+1|n+1) is based on both the model-based threat propagation prediction \hat{x}(n+1|n) and the observed sensor data z(n+1). The updated threat propagation estimate \hat{x}(n+1|n+1) becomes the current state estimate \hat{x}(n|n) in the next iteration.

The example described with respect to FIG. 4, in which a threat propagation estimate \hat{x}(n+1|n+1) is updated at each time step based on both the threat propagation model M and updated sensor data z(n+1), illustrates one method in which threat propagation estimates may be generated. In other exemplary embodiments, threat propagation estimates \hat{x}(n+1|n+1) may also be generated at multiple time intervals into the future to illustrate the estimated propagation of the threat through a region (e.g., threat propagation estimates may be generated at successive time intervals without waiting for updated sensor data). In this way, the threat propagation estimates \hat{x}(n+1|n+1) may be generated many time steps into the future to provide first responders and others with information regarding how the threat is expected to propagate. As updated sensor data z(n+1) (either data indicative of concentrations levels associated with a threat, or other sensors reporting detection of a threat) become available, the threat propagation estimates \hat{x}(n+1|n+1) are updated. In this way, threat propagation estimates \hat{x}(n+1|n+1) are improved or fine-tuned as new sensor data becomes available.

In an exemplary embodiment shown in FIG. 4, the covariance estimate P(n+1|n+1) is generated as an output along with the threat propagation estimate \hat{x}(n+1|n+1). Whereas the threat propagation estimate \hat{x}(n+1|n+1) indicates the best guess or estimate regarding threat propagation, the covariance P(n+1|n+1) indicates the level of confidence associated with the threat propagation estimate \hat{x}(n+1|n+1). As discussed above, the term threat propagation estimate refers broadly not only to estimates regarding the expected propagation of the threat through the region, but also to reliability data such as the covariance estimate P(n+1|n+1), which is calculated in conjunction with estimates regarding the estimated movement of the threat throughout the region.

Calculating or updating of the covariance estimate begins with a current estimate of the covariance P(n|n). At step 48, a covariance prediction P(n+1|n) (similar to the threat propagation prediction made at step 40) is generated based on the threat propagation model M, a previous covariance estimate P(n|n), a Jacobian evaluation of the threat propagation model M^{T}, and a noise value Q associated with the estimate. At step 50, a residual covariance S(n+1) is calculated based on the threat propagation model M, a covariance prediction P(n+1|n), a Jacobian evaluation of the threat propagation model M^{T} and a sensor model. Based on the calculations made at steps 48 and 50, the covariance prediction P(n+1|n), the Jacobian evaluation of the threat propagation model M^{T}, and an inverse representation of the residual covariance S(n+1)⁻¹ are used to calculate the optimal Kalman gain K(n+1) at step 52.

The gain coefficient K(n+1) represents the confidence associated with the sensor data based on both the sensor model R and the threat propagation model M, such that the updated threat propagation estimate \hat{x}(n+1|n+1) reflects the determination of which input is most reliable. That is, if the confidence level associated with the sensor data is high (or confidence in the threat propagation model is low), then gain value K(n+1) as applied to the innovation value u(n+1) at step 46 results in the threat propagation estimate providing more weight to the sensor data z(n+1) than the result of the threat propagation prediction \hat{x}(n+1|1) generated by threat propagation model M. Likewise, if the gain value K(n+1) indicates a low confidence associated with the sensor data z(n+1) (or confidence in the model-based threat propagation estimate \hat{x}(n+1|n) is high), then the updated threat propagation estimate \hat{x}(n+1|n+1) will be more heavily influenced by the result of threat propagation prediction \hat{x}(n+1|n) and less by the associated sensor data z(n+1). For instance, in a situation in which sensors are destroyed by smoke or fire, then the associated confidence of their outputs is decreased such that threat propagation estimates are more heavily influenced by the result of applying threat propagation model M to the state estimate \hat{x}(n|n).

At step 54, the state covariance P(n|n) is updated based on the gain value K(n+1), threat propagation model M, and the predicted covariance P(n+1|n) to generate an updated covariance value P(n+1|n+1). This value reflects the confidence level in the occupancy estimate value \hat{x}(n+1|n+1).

In the embodiment shown in FIG. 4, threat propagation algorithm 38 provides a fusing or combining of sensor data z(n+1) and model-based threat propagation estimates \hat{x}(n+1|n) generated based on a threat propagation model M. In particular, this method applies Extended Kalman Filter techniques to both the sensor data z(n+1) and the threat propagation model M to generate a threat propagation estimate \hat{x}(n+1|n+1) that takes into account the reliability of these inputs. The result is a threat propagation estimate \hat{x}(n+1|n+1) that is highly reliable and a covariance estimate P(n+1|n+1) that provides an indication of reliability associated with the threat propagation. In other embodiments, algorithms other than an Extended Kalman Filter may be employed to generate threat propagation estimates that make use both of sensor data z(n+1) provided by threat detection sensors and threat propagation models M. In other embodiments, data in addition to threat propagation estimates and reliability data (e.g., covariance) may be generated as part of the threat propagation estimate.

In addition, in an exemplary embodiment the threat propagation estimate \hat{x}(n+1|n+1) provided by threat propagation algorithm 38 is generated in real-time, allowing the threat propagation estimate \hat{x}(n+1|n+1) to be used in real-time applications (e.g., as input to first responders). This is a function both of the type of threat propagation model M employed (e.g., the Markov model described with respect to FIG. 3) as well as the algorithm (e.g., the Extended Kalman Filter described with respect to FIG. 4) used to combine sensor data z(n+1) and threat propagation model M. In an exemplary embodiment, a threat propagation estimate may be used for forensic or after the fact estimates of how a threat propagated through a region. In yet another exemplary embodiment, the threat propagation estimate can be used to predict threat propagation estimates into the near future (i.e., estimating the location of threats at various intervals, from a number of seconds into the future to a number of minutes). By predicting the propagation of threats into the future, first responders or egress support systems are able to plan evacuation routes for occupants. In addition, in exemplary embodiments a threat propagation estimates may be provided to occupant estimation systems to generate occupant estimates (i.e., estimates regarding the likely location of occupants in a region) based on the likely response of occupants to the propagation of the threat.

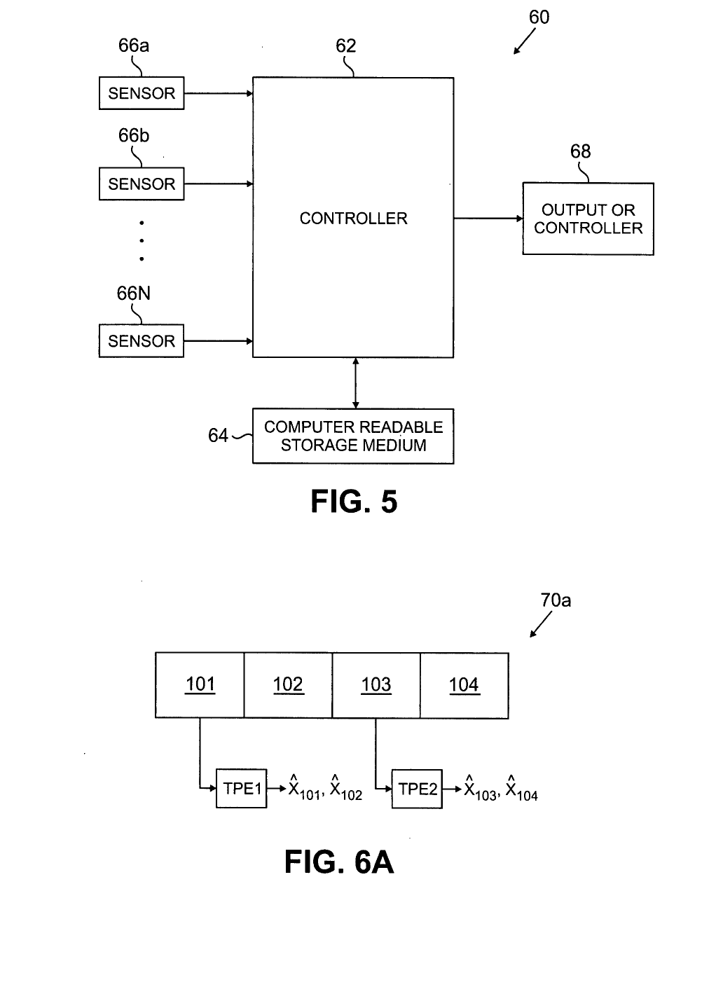

FIG. 5 illustrates an exemplary embodiment of a centralized system 60 for providing threat propagation estimates for a region (e.g., such as the building shown in FIG. 1). Centralized system 60 includes computer or controller 62, computer readable medium 64, a plurality of sensor devices 66a, 66b, . . . 66N, and display or controller. Controller 62 is connectable to receive sensor data from a plurality of sensor devices 66a, 66b, . . . 66N, and to provide a threat propagation estimate output to device 68. Sensor devices 66a-66N are distributed throughout a particular region, and may include a variety of different types of sensors, including traditional smoke detectors, concentration-level smoke detectors, video detectors, chemical or toxin detectors, as well as other well-known sensors used to detect the presence of threats.

The sensor data is communicated to controller 54. Depending on the type of sensors employed, and whether the sensors include any ability to process captured data, processor 64 may provide initial processing of the provided sensor data. For instance, video data captured by a video camera sensing device may require some video data analysis pre-processing to determine whether the video data shows a threat such as fire or smoke. In addition, this processing performed by processor 64 may include storing the sensor data, indicating type of threat detected as well as location of detected threat to an array or vector such that it can be supplied as an input to the threat propagation algorithm (e.g., an Extended Kalman Filter). The array or vector may be stored in memory 62 prior to being applied to the threat propagation algorithm.

In the embodiment shown in FIG. 5, controller 62 executes steps or processes to generate a threat propagation estimate. For instance, in an exemplary embodiment this may include performing the functions and operations described with respect to FIG. 4. Thus, the disclosed invention can be embodied in the form of computer or controller implemented processes and apparatus for practicing those processes. The present invention can also be embodied in the form of computer program code containing instructions embodied in computer readable medium 64, such as floppy diskettes, CD-ROMS, hard drives, or any other computer readable storage medium, wherein, when the computer program code is loaded onto and executed by computer 54. The computer becomes an apparatus for practicing the invention. The present invention may also be embodied in the form of computer code as a data signal, for example, whether stored in a storage medium 64, loaded onto and/or executed by controller 62, or transmitted over some transmission medium, such as over electrical wiring or cabling, through fiber optics, or via electromagnetic radiation, wherein, when the computer program code is loaded into and executed by controller 62, the controller becomes an apparatus for practicing the invention. When implemented on a general purpose microprocessor, the computer program code segments configure the microprocessor to create specific logic circuits.

For example, in an exemplary embodiment, computer rendable storage medium 64 may store program code or instructions embodying the threat propagation model M, sensor model H, and a threat propagation algorithm (e.g., Extended Kalman Filter). The computer code is communicated to controller 62, which executes the program code to implement the processes and functions described with respect to the present invention (e.g., executing those functions described with respect to FIG. 3). As shown in FIG. 5 based on the sensor data received from one or more of the plurality of sensors 66a-66N, the threat propagation model and sensor model, processor 64 executes the threat propagation algorithm to generate a threat propagation estimate. The resulting threat propagation estimate is communicated to device or devices 68. In an exemplary embodiment, device 68 is a hand-held device employed by first responders to receive information regarding the estimated propagation of the threat through a region as well as estimates regarding the likely source of the threat. In other exemplary embodiments, device 68 may be part of an egress support system that dynamically generates evacuation routes that are then communicated to occupants within the building. Providing the egress support system with the threat propagation data allows the egress support system to devise and optimize evacuation routes of occupants. The threat propagation data may be provided via any number of communication networks, including telecommunication networks, wireless networks, as well as other well known communication systems.

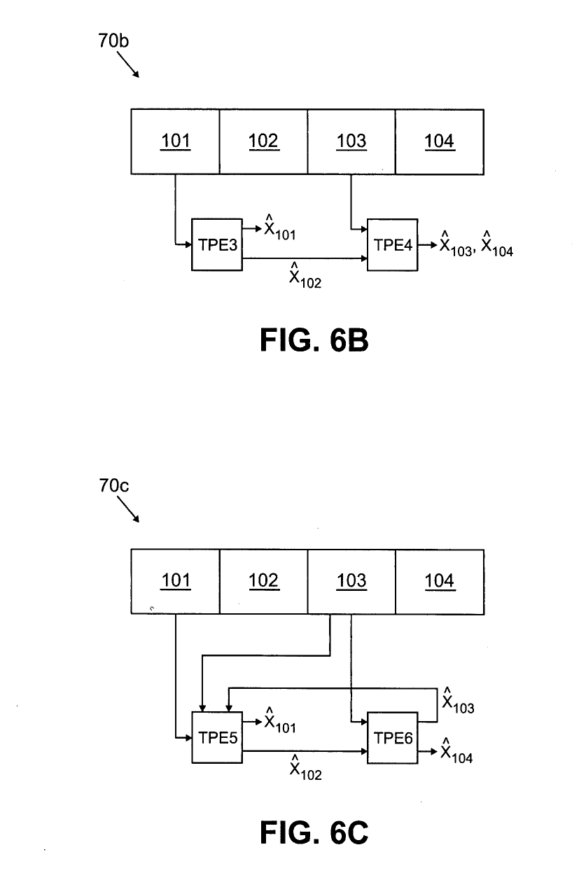

In contrast to the centralized threat propagation system described with respect to FIG. 5, FIGS. 6A-6C illustrate a number of distributed threat propagation systems 70a, 70b, and 70c for generating threat propagation estimates. For the sake of simplicity, the examples shown in FIGS. 6A-6C include only four sub-regions (labeled sub-regions 101, 102, 103, and 104), although the concepts illustrated in these examples could be expanded to an area or building having any number of sub-regions.

In the embodiment shown in FIG. 6A, distributed threat propagation system 70a includes sensor devices are located in sub-regions 101 and 103, wherein each sensor device (or associated hardware) includes the capability of processing the data provided by the associated sensor device and applying an algorithm (e.g., Extended Kalman Filter) based on the processed sensor data and a threat propagation model to generate a threat propagation estimate. For purposes of this description, the distributed threat propagation system 70a that includes both the sensor device and the components used to generate the threat propagation estimate, which may include a combination of hardware and software for applying the algorithm to the threat propagation model and the sensor data will be referred to generally as threat propagation estimator (TPE). In the embodiment shown in FIG. 6A, sensor data observed at sub-region 101 is provided to threat propagation estimator TPE1, which generates threat propagation estimates \hat{x}₁₀₁(t) and \hat{x}₁₀₂(t) corresponding to sub-regions 101 and 102, respectively. Sensor data observed at sub-region 103 is provided to threat propagation estimator TPE2, which generates threat propagation estimates \hat{x}₁₀₃(t) and \hat{x}₁₀₄(t) corresponding to sub-regions 103 and 104, respectively. In the embodiment shown in FIG. 6A, the threat propagation estimator TPE1 and threat propagation estimator TPE2 do not share information regarding the threat propagation estimates of the respective sub-regions.

In distributed system 70B shown in FIG. 6B, sensor devices are once again located at sub-regions 101 and 103. In this embodiment however, threat propagation estimate \hat{x}₁₀₂(t) generated by threat propagation estimator TPE3 is provided as an input to threat propagation estimator TPE4. A benefit of distributed system 70b is the ability of threat propagation estimator TPE4 to base threat propagation estimates \hat{x}₁₀₃(t) and \hat{x}₁₀₄(ₜ) in part on knowledge regarding the threat propagation estimates generated for sub-region 102. For instance, if the threat propagation estimate \hat{x}₁₀₂(t) indicates that a threat has propagated into sub-region 102, then threat propagation estimator TPE4 may predict that in the next time step the threat located in sub-region 102 will propagated from sub-region 102 to sub-region 103, thereby improving the predicted threat propagation estimation by incorporating data from adjacent or nearby sub-regions.

In distributed system 70c shown in FIG. 6C, sensor devices are once again located at sub-regions 101 and 103. In this embodiment however, threat propagation estimate \hat{x}₁₀₂(t) made by threat propagation estimator TPE5 is provided as an input to threat propagation estimator TPE6, and both sensor data from sub-region 103 and threat propagation estimate \hat{x}₁₀₃(t) are provided as input to threat propagation estimator TPE5. This embodiment illustrates a distributed application in which both threat propagation estimates and sensor data is shared by associated threat propagation estimators. A benefit of this system is the ability of threat propagation estimators TPE5 and TPE6 to base threat propagation estimates on the additional data made available, thus improving the overall reliability and performance of distributed system 70c.

Communication of threat propagation estimations between threat propagation estimators may be provided via typical communication networks, including telecommunication networks, local area network (LAN) connections, or via wireless networks. In addition, in some embodiments communication costs are minimized by only sharing threat propagation estimates between adjacent sub-regions, such that only those threat propagation estimators monitoring adjacent sub-regions share threat propagation estimates. A benefit of employing distributed systems for providing threat propagation estimates is the ability of distributed systems to function despite the loss of one or more of the individual threat propagation estimators.

Although the present invention has been described with reference to preferred embodiments, workers skilled in the art will recognize that changes may be made in form and detail without departing from the spirit and scope of the invention. For example, although a computer system including a processor and memory was described for implementing the threat propagation algorithm, any number of suitable combinations of hardware and software may be employed for executing the mathematical functions employed by the threat propagation algorithm. In addition, the computer system may or may not be used to provide data processing of received sensor data. In some embodiments, the sensor data may be pre-processed before being provided as an input to the computer system responsible for executing the threat propagation algorithm. In other embodiments, the computer system may include suitable data processing techniques to internally process the provided sensor data.

In addition, a number of embodiments and examples relating to the use of the threat propagation system for use in a building, although the system is applicable to other field or applications that may find a beneficial use to threat propagation estimations. Furthermore, through the specification and claims, the use of the term ‘a’ should not be interpreted to mean “only one”, but rather should be interpreted broadly as meaning “one or more”. The use of sequentially numbered steps used throughout the disclosure does not imply an order in which the steps must be performed. The use of the term “or” should be interpreted as being inclusive unless otherwise stated.

1. A system for generating threat propagation estimates for a region, the system comprising:
an input operably connected to receive sensor data from one or more sensor devices;
a threat propagation estimator operably connected to the input, wherein the threat propagation estimator executes an algorithm to generate a threat propagation estimate for a region based on the received sensor data and a model-based threat propagation estimate generated by a threat propagation model; and
an output operably connected to the threat propagation estimator to communicate the threat propagation estimate generated by the threat propagation estimator.

2. The system of claim 1, wherein the threat propagation model generates the model-based threat propagation prediction based, in part, on a previous threat propagation estimate.

3. The system of claim 1, wherein the algorithm executed by the threat propagation estimator calculates a weighting parameter based on the received sensor data, the threat propagation model, and a sensor model and generates the threat propagation estimate based on the calculated weighting parameter.

4. The system of claim 1, wherein the threat propagation estimator generates the threat propagation estimates in real-time.

5. The system of claim 1, wherein the threat propagation estimate is an estimate of a distribution of particles in the region, a probability associated with the estimate of particle distribution, a reliability estimate, an estimate regarding a source of the threat, an estimate regarding estimated propagation of the threat at future points in time, or a combination thereof.

6. The system of claim 5, wherein the reliability estimate includes a covariance value or a standard deviation value calculated with respect to the region.

7. The system of claim 1, wherein the threat propagation model is a mathematical model, a computer simulation, a statistical model, or a combination thereof.

8. The system of claim 7, wherein the threat propagation model is generated in response to a computational fluid dynamic model, a zonal model, or a combination thereof.

9. The system of claim 1, wherein the algorithm employed by the threat propagation estimator is an Extended Kalman Filter that generates threat propagation estimates that include a probability associated with a threat propagating to the region and a covariance associated with each probability.

10. The system of claim 1, wherein the system is a centralized system in which the threat propagation estimator is operatively connected to receive data from a plurality of sensors located throughout the region and in response generates the threat propagation estimate.

11. The system of claim 1, wherein the system is a distributed system including a plurality of threat propagation estimators, wherein each of the plurality of threat propagation estimators receives sensor data associated with a proximate location of the region and executes an algorithm to generate a threat propagation estimate for the proximate location based on the received sensor data and a threat propagation model associated with the proximate location.

12. The system of claim 11, wherein one of the plurality of threat propagation estimators is connected to an adjacent threat propagation estimator to receive threat propagation estimates generated by the adjacent threat propagation estimator with respect to a distal, location, wherein the threat propagation estimator incorporates the threat propagation estimate with respect to the distal location in generating the threat propagation estimate for the proximate location.

13. The system of claim 11, wherein one of the plurality of threat propagation estimators is connectable to receive sensor data from both a proximate location and a distal location, wherein the threat propagation estimator incorporates the sensor data received with respect to the distal location in generating the threat propagation estimate for the proximate location.

14. A method for estimating threat propagation in a region, the method comprising:
acquiring sensor data from one or more sensor devices;
calculating a model-based threat propagation estimate based on a threat propagation model that predicts movements of threats within a region; and
generating a threat propagation estimate for the region based on a combination of the acquired sensor data and the model-based threat propagation estimate.

15. The method of claim 14, wherein calculating the model-based threat propagation estimate includes applying the threat propagation model to a previous threat propagation estimate.

16. The method of claim 14, wherein generating a threat propagation estimate further includes:
calculating a weighting parameter associated with the acquired sensor data and the model based threat propagation estimate; and
generating the threat propagation estimate based, in addition, on the calculated weighting parameter.

17. The method of claim 14, wherein the threat propagation model generates the mode-based threat propagation estimate in real-time.

18. The method of claim 16, wherein generating an occupancy estimate further includes:
calculating a measurement prediction based on the model-based threat propagation estimate and a sensor model;
calculating an innovation estimate based on a comparison of the measurement prediction to the acquired sensor data; and
applying the weighting parameter to the innovation estimate and combining with the measurement prediction to generate the occupancy estimate.

19. A threat estimation system, comprising:
means for acquiring sensor data relevant to threat detection;
means for calculating a model-based threat propagation estimate based on a threat propagation model that predicts the propagation of threats within a region; and
means for generating an threat propagation estimate based on a combination of the acquired sensor data and the model-based threat propagation estimate.

20. A distributed system for estimating the propagation of threats within a region, the system comprising:
a first threat propagation estimator connectable to receive sensor data associated with a first location and for executing an algorithm to generate a first threat propagation estimate for the first location based on the received sensor data associated with the first location and a model-based threat propagation estimate generated for the first location by a first threat propagation model; and
a second threat propagation estimator connectable to receive sensor data associated with a second location and for executing an algorithm to generate a second threat propagation estimate for the second location based on the received sensor data associated with the second location and a model-based threat propagation estimate generated for the second location by a second threat propagation model.

21. The distributed system of claim 20, further including:
a communication network connecting the first threat propagation estimator to the second threat propagation estimator, wherein the first threat propagation estimator communicates the first threat propagation estimate to the second threat propagation estimator.

22. The distributed system of claim 21, wherein the second threat propagation estimator communicates the second threat propagation estimate to the first threat propagation estimator, wherein the first threat propagation estimator generates the first threat propagation estimate based, in addition, on the second threat propagation estimate.

23. The distributed system of claim 20, wherein the first threat propagation estimator is connectable to receive sensor data associated with the second location, wherein the first threat propagation estimator generates the first threat propagation estimate based, in addition, on the sensor data associated with the second location.

24. A computer readable storage medium encoded with a machine-readable computer program code for generating threat propagation estimates for a region, the computer readable storage medium including instructions for causing a controller to implement a method comprising:
acquiring sensor data from one or more sensor devices;
calculating an model-based threat propagation estimate based on a threat propagation model that predicts movements of threats within a region; and
generating a threat propagation estimate for the region based on a combination of the acquired sensor data and the model-based threat propagation estimate.
